(19) United States
(12) Patent Application Publication
(10) Pub. No.: US 2009/0078797 A1
(43) Pub. Date: Mar. 26, 2009

(54) ARRANGEMENT OF INJECTION SYSTEMS IN AN AIRCRAFT ENGINE COMBUSTION CHAMBER END WALL

(75) Inventors: Didier Hippolyte HERNANDEZ, Quiers (FR); Thomas Olivier Marie Noel, Vincennes (FR)

Correspondence Address: OBLON, SPIVAK, MCCLELLAND MAIER & NEUSTADT, P.C., 1940 DUKE STREET, ALEXANDRIA, VA, 22314, US

(73) Assignee: SNECMA, Paris (FR)

(21) Appl. No.: 12/235,965

(22) Filed: Sep. 23, 2008

(30) Foreign Application Priority Data
Sep. 24, 2007 (FR) 0757791

(51) Int. Cl. B05B 1/14

(52) U.S. Cl. 239/558

(57) ABSTRACT

The invention relates to an arrangement of injection systems each fixed into a hole in a combustion chamber end wall by a fixing device.

An injection part and a fixing part, extending at the periphery of the hole by projecting on the injection stem side has a shape that is oblong with secant straight lines, the longest dimension of the oblong shape running radially with respect to the chamber end wall with secant straight lines. This can be achieved by:
reducing the size of an injection and fixing part by truncating its diameter using a flat which extends radially and by positioning adjacent flats parallel to one another,
making holes of oblong cross section with tangential straight lines and, respectively, injection parts that pass through the hole with a cylindrical shape so as to have a radial operating clearance (jr) that is greater than the tangential operating clearance (jt).

### TECHNICAL FIELD AND PRIOR ART

The invention relates to the arrangement of injection systems in an end wall of the combustion chamber of an aircraft engine, such as a turbomachine or turboprop.

Turbomachine combustion chambers have a combustion chamber end wall at the periphery of which injection systems are mounted such that they are uniformly distributed. The injection systems, in each of which fuel injectors are mounted, are designed to deliver a mixture of air and fuel which is then ignited to provide the combustion gases.

At the present time, the injection systems used deliver a quantity varying between 10 and 25% of the air which passes through the combustion chamber. Thus, the size of each injection system is small by comparison with that of the chamber. In addition, the injection systems are distributed uniformly at the periphery of the chamber end wall in such a way that two adjacent injection systems are always separated from one another.

At the present time also, the differential expansions that take place during combustion between the combustion chamber and its surrounding casing may be so high that it is necessary to provide a significant operating clearance at the connection where each injector meets its injection system, so as to compensate for said differential expansions. Typically, the operating clearance provided may be of the order of 3 mm.

New-generation injection systems known as multipoint injection systems introduce up to 70% of the air that passes through the combustion chamber. Thus, the size of each multipoint injection system is greater than that of present-day injection systems. Further, the multipoint fuel is delivered at the periphery of the multipoint injector. It is therefore necessary, in order to have effective mixing of the multipoint fuel with the air injected by the injection system, not to have the operating clearance in the injection system at its part that is in direct contact with the injector. In other words, it is necessary to move the aforementioned operating clearance to the region where the injection system is fixed to the chamber end wall.

As a result, the combination of constraints imposed by the increase in size of the injection systems and by the moving of the operating clearance to the region attachment to the chamber end wall means that each individual region where the injection systems are fixed to the chamber end wall has to occupy a greater amount of space.

However, the chamber end wall diameter is fixed and limited by design. Hence, in certain cases, by keeping all the other design parameters the same, the end result may be geometric interference between consecutive regions of attachment of injection systems.

This is why one objective of the invention is to propose a solution which makes it possible not to have any geometric interference between consecutive regions of attachment of new-generation injection systems while at the same time maintaining the performance thereof.

### SUMMARY OF THE INVENTION

To this end, the invention proposes an aircraft engine combustion module comprising:
a combustion chamber end wall the periphery of which has a plurality of open-ended holes separated from one another,
a plurality of multipoint injection systems each mounted in one of the holes in the chamber end wall with operating clearance and each comprising a projecting part which extends at a periphery of the hole,
a plurality of fixing devices each for fixing a multipoint injection system to the chamber end wall and each comprising a projecting part which extends at the periphery of the hole on the injection system side, and

in which the operating clearance of the injection systems is in the region of the fixing to the chamber end wall and in which each projecting part of the multipoint injection systems peripheral to the hole and each projecting part of the fixing devices peripheral to the hole on the injection systems side has a shape that is oblong with secant straight lines which has a section transverse to the axis of injection in which the straight parts meet a curve along a secant rather than a tangent, the longest dimension of the oblong shape with secant straight lines running in the radial direction XX′ of the chamber end wall.

What “oblong shape with secant straight lines” means here and in the context of the invention is a shape that has a section transverse to the axis of injection in which the straight parts meet a curve along a secant rather than a tangent. For example, the shape may be that of the same circle truncated by two straight-line segments parallel to the radial direction of the chamber end wall.

By giving part of the fixing devices and of the injection systems that projects on the side of the hole facing the injection a shape that is oblong with secant straight lines across their width, the geometric interference that would result from two injection systems and adjacent associated fixing devices with intersecting diameters is eliminated.

Advantageously, each projecting part of the multipoint injection systems peripheral to the hole and each projecting part of the fixing devices peripheral to the hole on the multipoint injection systems side has an external shape that is cylindrical truncated by a flat so that the fixing devices and adjacent injection systems sit side by side with their flats parallel to one another.

It goes without saying that a person skilled in the art will take care to ensure that the functions of the fixing devices are fulfilled and that the ventilation of the injection systems is not adversely affected.

It goes without saying that the truncation thus performed is suitable provided that the elements of the fixing devices maintain their functions and provided that the ventilation of the injection systems is not adversely affected.

According to one alternative form of embodiment, each projecting part of the multipoint injection systems has an injection bowl rim externally truncated by a flat.

According to this same alternative form of embodiment, each projecting part of the fixing devices comprises a ring and a sleeve, each of cylindrical external shape truncated by a flat and between which the truncated injection bowl rim is held such that it can slide.

According to a first advantageous embodiment of the invention:
each hole has a cylindrical shape,
each part of the multipoint injection systems and each part of the fixing devices that pass through the corresponding hole respectively has a cylindrical external shape and a cylindrical internal shape homothetic with the shape of the corresponding hole so that the radial operating clearance is equal to the tangential operating clearance.

According to a second advantageous embodiment:
each hole has an oblong shape with tangential straight lines, with the longest dimension of the oblong section with tangential straight lines running in the radial direction of the chamber end wall,
each part of the multipoint injection systems and each part of the fixing devices, passing through the corresponding hole respectively has a cylindrical external shape and an internal shape that is oblong with tangential straight lines homothetic with the shape of the corresponding hole so that the radial operating clearance is greater than the tangential operating clearance.

What “oblong shape with tangential straight lines” means here and in the context of the invention is a shape that has a section transverse to the axis of injection in which straight parts meet a curve at a tangent. For example, the shape may be that of two semicircles of the same diameter joined together by two straight-line segments parallel to the radial direction of the chamber end wall.

At the present time, the known injection systems are mounted in their fixing device such that they can slide in order to compensate for relative radial movements between combustion chamber and combustion casing, which movements are caused by differences in differential expansion between these two parts during combustion. An operating clearance, with the magnitude of the movements, is built into the region of sliding defined between the exterior part of the injection system and the interior part of the fixing device that passes through the hole.

Owing to the current method of manufacture, the chamber end wall holes, the components of the injection systems and their associated fixing devices are always made with a cylindrical shape. Hence, by construction, the operating clearance needed to compensate for the radial movements is the same in the tangential direction. The inventors have established that the operating clearance is therefore not needed in this tangential direction. According to the second embodiment of the invention, by giving the hole in the chamber end wall, the fixing device, and the region of sliding of the injection system a shape that is oblong with tangential straight lines, the magnitude of the tangential operating clearance can be recouped thus gaining space in which to fit the injection systems.

In the cases of the most extreme possible geometric interference, the tangential operating clearance may be zero. In other words, in the tangential direction, there only remains an assembly clearance between the part of the injection system, such as a bowl, and the fixing part in the region of the hole in the chamber end wall.

According to this second embodiment, each fixing device may comprise a non-projecting part which extends at the periphery of the hole on the multipoint injection system side and is of a shape homothetic with that of the hole so that the injection system can be mechanically held in the chamber end wall if the welding and/or brazing that joins the parts of the fixing device together and/or to the chamber end wall should fail.

The non-projecting part which provides mechanical retention preferably comprises an elastically deformable snap ring placed in contact with the hole and housed inside a groove made in the sleeve.

Conventionally, in order to provide the above-mentioned mechanical retention, also known as the “FAIL SAFE” function, use is made of a system of stop dogs, which system cannot be applied to components the shape of which is that of an oblong with secant straight lines. According to the invention, the elastic snap ring with a shape such as this effectively performs the “FAIL SAFE” function around the hole.

Each part of the multipoint injection systems passing through the hole may comprise an injection bowl part of cylindrical shape.

The injection bowl may further comprise a flange the external shape of which is oblong with tangential straight lines homothetic with the internal shape of the part of the fixing devices passing through the hole.

The invention finally relates to a turbomachine comprising a combustion module defined hereinabove.

### BRIEF DESCRIPTION OF THE DRAWINGS

Further advantages and features of the invention will become more clearly apparent from studying the exemplary embodiments given solely by way of illustration and by referring to the following figures among which:

FIG. 1 is a schematic perspective view of an aircraft engine combustion chamber end wall to which two conventional injection systems are fixed,

FIG. 2 is a schematic perspective view of an aircraft engine combustion chamber end wall to which two adjacent multipoint injection systems would be fixed in a similar way to FIG. 1,

FIG. 3 is a schematic front view of an aircraft engine combustion chamber end wall to which two adjacent multipoint injection systems are fixed according to a first embodiment of the invention,

FIGS. 3A, 3B and 3C are views of FIG. 3 in section on A-A, in section on B-B, and an exploded perspective view, respectively,

FIGS. 4A, 4B and 4C are, respectively, views in longitudinal section on a radial plane and on a tangential plane B-B, and an exploded perspective view of a combustion chamber end wall, of part of an injection system, and of the associated fixing device according to a second embodiment of the invention.

### DETAILED DESCRIPTION OF SPECIFIC EMBODIMENTS

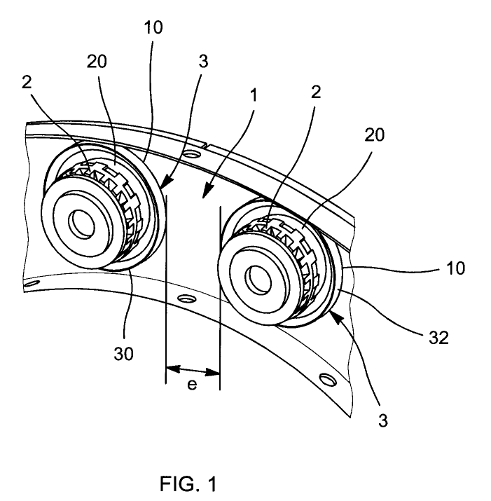

FIG. 1 depicts a peripheral region of the chamber end wall 1 of a turbomachine as currently in existence.

Fixed adjacent to one another in this region are two injection systems 2, each fixed into a hole 10 in the chamber end wall 1. Fixing is performed using a fixing device 3 known per se, of which a part 30 of cylindrical shape homothetic with the shape of the hole 10, passes through this hole.

Thus, according to the state of the art, two adjacent injection systems 2 are spaced apart by a certain distance e (distance measured from the outside of the projecting parts 32 of the fixing device 3).

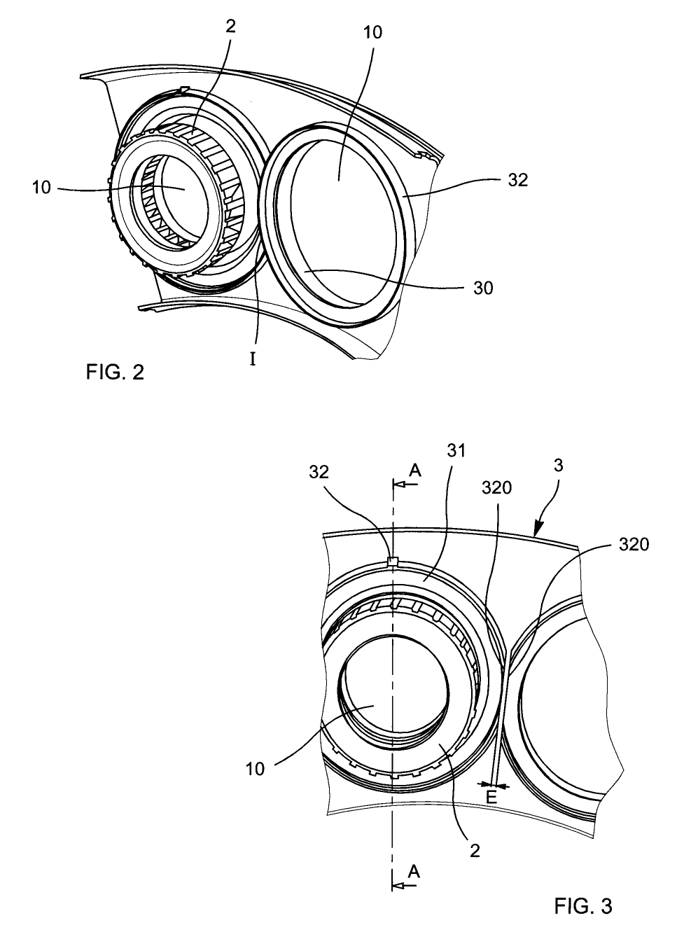

FIG. 2 is a virtual depiction of a region of the same turbomachine chamber end wall 1 of FIG. 1, but in which two new-generation injection systems, of the multipoint type 2, would be fitted if they were fixed into the holes 10 in the same way as the injection systems 2 of FIG. 1.

What “fixed in the same way” means here is multipoint injection systems fixed in position using conventional fixing devices 3 that have the same types of component, arranged in the same way, and on the same scale as their associated injection system in order to obtain the same operating and fixing characteristics and, in particular, the same operating clearance between the multipoint injection system and the conventional fixing device.

In the approach currently adopted, each injection system 2 comprises, in the form of a one-piece component, an injection bowl 20. This bowl 20 first of all comprises an internally divergent cone 200 designed to explode a jet, that is a mixture of air and of fuel, supplied by the other elements of the injection system. It also comprises a flange 201 which extends at the end of the cone 200 downstream of the injection. The one-piece bowl 20 also comprises a rim 202 to hold the bowl such that it can slide in the fixing device 3. The bowl 20 finally comprises a retaining part 203 positioned substantially orthogonal to the flange 201 and to the rim 202 and connecting the cone 200 to the rim. In the current design, the flange 201, the rim 202 and the retaining part 203 each have a cylindrical external shape.

It is clearly evident from studying FIG. 2 that it is impossible to fit multipoint injection systems of larger diameter onto a chamber end wall that has the same diameter as the one in FIG. 1 using the same components and with the injection systems 2 and associated fixing devices 3 arranged in the same way. Specifically, fitting the components in this way would entail there being a region of geometric interference I that cannot be obtained by construction.

The inventors have thus reached the conclusion that the dimensions of the new-generation injection elements need to be reduced, by reducing at least the dimensions of the injection systems 2 and those of the associated fixing devices 3 that project on that side of the hole that is upstream of the injection (that is to say on the chamber end wall 10 side facing the reader in FIG. 1).

According to the invention, each projecting part 202 of the injection systems peripheral to the hole and each projecting part 31, 32 of the fixing devices peripheral to the hole on the side of the injection systems 2a has the shape of an oblong with secant straight lines, the longest dimension of the oblong shape with secant straight lines running in the radial direction XX′ of the chamber end wall 1. In other words, in the two embodiments illustrated, on the one hand, the injection bowl 20 of each injection system has a rim 202 of cylindrical shape externally truncated by a flat 2020 and, on the other hand, the ring 31 and the sleeve 32 of the fixing devices 3 has a cylindrical external shape truncated by a flat 310, 320 and between which flats the truncated bowl rim 202 is held such that it can slide. The flats 2020, 310 and 320 are therefore fitted amongst one another in the fixed position.

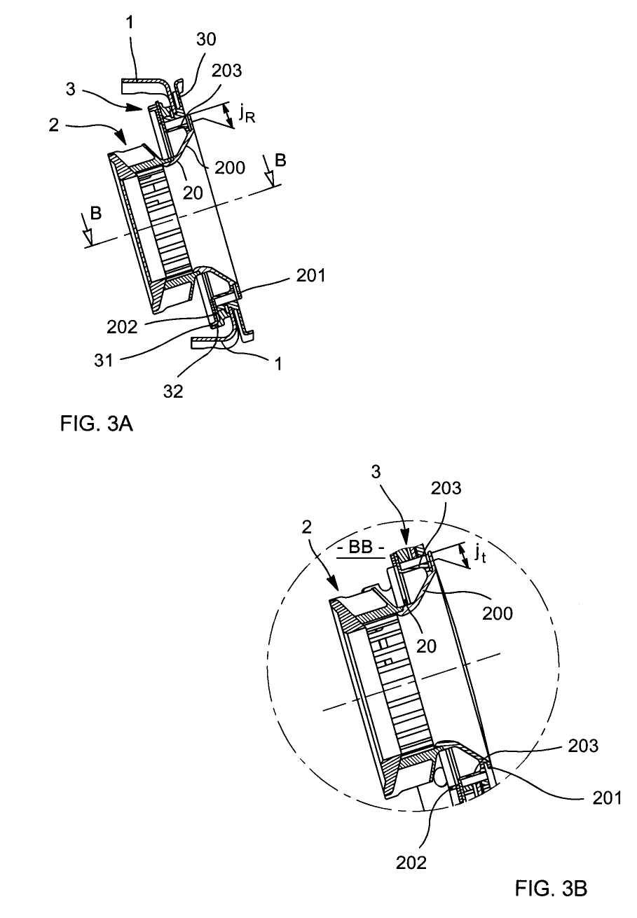

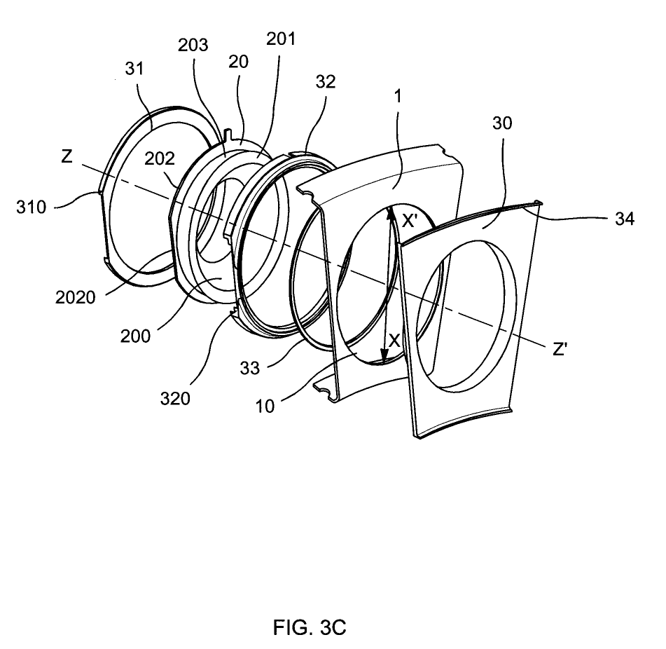

Thus, for the configurations in which the geometric interference is fairly great, a first solution is to truncate the cylindrical shape for part 31, 32 of the fixing devices with a flat 310, 320 and for part 20 of the injection system using a flat 2020 and for the latter flat to be sandwiched by the other two 310, 320. Thus, once positioned, the two adjacent outside flats 320 of the fixing devices (FIG. 3) such that they are mutually parallel. As a preference the minimum clearance E between two parallel adjacent flats 320 is at least 0.5 mm.

According to the first embodiment illustrated in FIGS. 3A, 3B and 3C, provision is therefore first of all made to keep the holes 10 of cylindrical shape separated from one another. Each through-part 200 of the injection bowls 2 and each part 30 of the fixing devices that pass through the corresponding hole 10 respectively has a cylindrical external shape and a cylindrical internal shape that is homothetic with the shape of the corresponding hole so that the radial operating clearance is equal to the tangential operating clearance. Thus, the radial operating clearance jr between the part 203 of the injection bowl 20 and the part 30 passing through the fixing device 3 surrounding it is equal to the tangential operating clearance jt between these same parts 203, 30 (FIGS. 3A and 3B).

It goes without saying that the truncation thus performed must be done taking care to ensure that, on the one hand, the fixing device 3 maintain their functions and their fixing properties and, on the other hand, the injection systems 2 maintain their injection properties. In particular, the ventilation of each injection system 2 must not be adversely affected.

Furthermore, it should be noted that the deflectors 34 are not cylindrical and are truncated in such a way as to cover the entire surface of the chamber end wall without there being any interference between two adjacent deflectors.

For the configurations in which the geometric interference is even greater, an additional second solution is first of all to make each hole 10 in the shape of an oblong with tangential straight lines, with the longest dimension of the oblong cross section with tangential straight lines running in the radial direction XX′ of the chamber end wall 1. This solution also involves making each part 200 of the injection bowl 20 and each part 30 of the fixing devices, that pass through the corresponding hole 10, with, respectively, an external shape that is oblong with tangential straight lines and an internal shape that is oblong with tangential straight lines homothetic with the shape of the corresponding hole so that the radial operating clearance is greater than the tangential operating clearance.

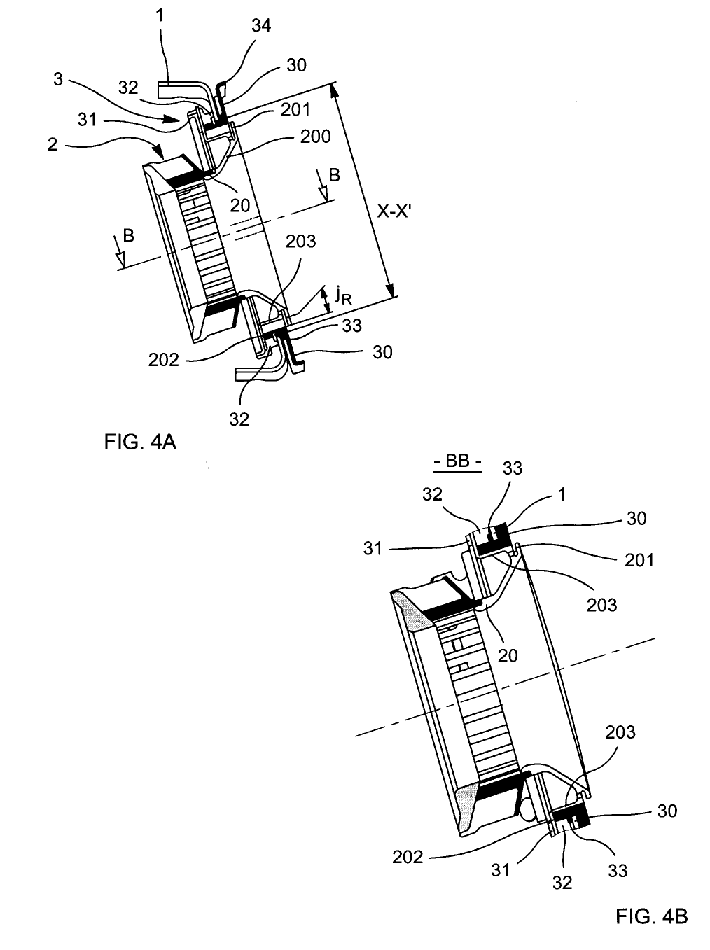

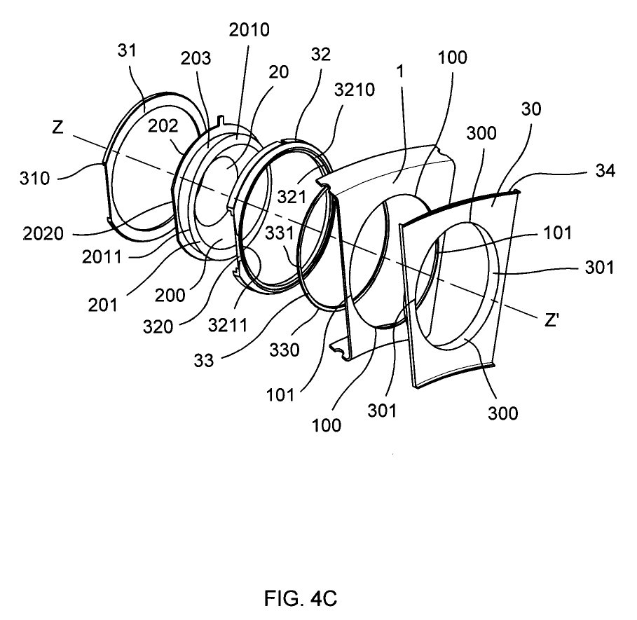

As illustrated in FIGS. 4A, 4B and 4C, each oblong shape with tangential straight lines according to the invention consists of two semicircles of the same diameter connected together by two straight lines parallel to the radial direction XX′ of the chamber end wall 1.

In particular, in FIG. 4C, and from right to left therein respectively:
the hole 10 made in the chamber end wall has a shape made up of two semicircles 100 of the same diameter connected together by two mutually parallel straight line segments 101,
the part 30 of the fixing device that passes through the hole 10 and that comprises the deflector 34 has an internal shape consisting of two semicircles 300 of the same diameter joined together by two mutually parallel straight line segments 301,
the snap ring 33, the function of which will be detailed hereinafter, has an internal and external shape consisting of two semicircles 330 of the same diameter joined together by two mutually parallel straight line segments 331,
the fixing sleeve 32 comprises a groove 321 consisting of two semicircles 3210 joined together by two mutually parallel straight line segments 3211,
the part 203 of the injection bowl passing through the hole 10 and housed in the part 300, 301 of the fixing device is cylindrical.

Thus, the radial operating clearance jr obtained between the part 203 of the injection system 2 and the part 30, 300, 301 of the fixing device 3 surrounding it (FIG. 4A) is greater than the tangential operating clearance between these same parts 30; 203 (FIG. 4B). As illustrated in FIG. 4B, the tangential operating clearance is zero, that is to say reduced to a simple assembly clearance between the part 203 and the inside of the part 30, 300, 301 that passes through the hole 10. In the embodiment of FIG. 4C, the flange 201 is made up of two semicircles 2010 joined together by two mutually parallel straight line segments 2011.

Conventionally, a stop dogs system is used to provide the FAIL SAFE function that ensures that the injection system 2 is mechanically retained in the chamber end wall 1 should the welding and/or brazing that fixes the parts 30, 32 of the fixing device 3 together and/or to the chamber end wall 1 fail. However, according to the additional second solution of the invention, a dogs system such as this does not apply because it applies only to parts of cylindrical shape. According to the invention, a mechanical retaining piece in the form of an elastically deformable snap ring 33 housed in the groove 321 of the sleeve 32 is provided.

It should be noted that, advantageously, in order to provide the FAIL SAFE function in the embodiment illustrated in FIGS. 3A, 3B and 3C, that is to say according to the first solution of the invention, a snap ring 33 of cylindrical shape is also provided.

In the solutions of the invention such as illustrated (FIGS. 3, 3A, 3B and 4, 4A and 4B), the part 30 of the fixing device that passes through the hole is a one-piece component which extends on the side of the hole 10 furthest downstream from the injection. This component therefore advantageously acts as a deflector 34 that protects the part of the chamber end wall 1 around the injection systems 2.

The invention that has just been described offers numerous advantages, including:
the elimination of any risk of geometric interference between injection systems,
the optimization of the complexity of the geometries of the injection systems and/or of the associated fixing devices according to need and the constraints placed upon availability of space,
a good relationship between the cost of modifying injection systems and/or associated fixing devices and the functionality achieved.

1. Aircraft engine combustion module comprising:
a combustion chamber end wall the periphery of which has a plurality of open-ended holes separated from one another,
a plurality of multipoint injection systems each mounted in one of the holes in the chamber end wall with operating clearance and each comprising a projecting part which extends at a periphery of the hole,
a plurality of fixing devices each for fixing a multipoint injection system to the chamber end wall and each comprising a projecting part which extends at the periphery of the hole on the injection system side, and
wherein the operating clearance of the injection systems is in the region of the fixing to the chamber end wall and in which each projecting part of the multipoint injection systems peripheral to the hole and each projecting part of the fixing devices peripheral to the hole on the multipoint injection systems side has a shape that is oblong with secant straight lines which has a section transverse to the axis of injection in which the straight parts meet a curve along a secant rather than a tangent, the longest dimension of the oblong shape with secant straight lines running in the radial direction of the chamber end wall.

2. Combustion module according to claim 1, wherein each projecting part of the multipoint injection systems peripheral to the hole and each projecting part of the fixing devices peripheral to the hole on the multipoint injection systems side has an external shape that is cylindrical truncated by a flat so that the fixing devices and adjacent injection systems sit side by side with their flats parallel to one another.

3. Combustion module according to claim 2, wherein each projecting part of the multipoint injection systems has an injection bowl rim externally truncated by a flat.

4. Combustion module according to claim 3, wherein each projecting part of the fixing devices comprises a ring and a sleeve, each of cylindrical external shape truncated by a flat and between which the truncated injection bowl rim is held such that it can slide.

5. Combustion module according to claim 1, wherein:
each hole has a cylindrical shape,
each part of the multipoint injection systems and each part of the fixing devices that pass through the corresponding hole respectively has a cylindrical external shape and a cylindrical internal shape homothetic with the shape of the corresponding hole so that the radial operating clearance is equal to the tangential operating clearance.

6. Combustion module according to claim 1, wherein:
each hole has an oblong shape with tangential straight lines, with the longest dimension of the oblong section with tangential straight lines running in the radial direction of the chamber end wall,
each part of the injection systems and each part of the fixing devices, passing through the corresponding hole respectively has a cylindrical external shape and an internal shape that is oblong with tangential straight lines homothetic with the shape of the corresponding hole so that the radial operating clearance is greater than the tangential operating clearance.

7. Combustion module according to claim 6, wherein the tangential operating clearance is zero.

8. Combustion module according to claim 6, wherein each fixing device comprises a non-projecting part which extends at the periphery of the hole on the multipoint injection system side and is of a shape homothetic with that of the hole so that the injection system can be mechanically held in the chamber end wall if the welding and/or brazing that joins the parts of the fixing device together and/or to the chamber end wall should fail.

9. Combustion module according to claim 8, wherein the non-projecting part which provides mechanical retention comprises an elastically deformable snap ring placed in contact with the hole and housed inside a groove made in the sleeve.

10. Module according to claim 6, wherein each part of the multipoint injection systems passing through the hole comprises an injection bowl part of cylindrical external shape.

11. Combustion module according to claim 10, in which the injection bowl further comprises a flange the external shape of which is oblong with tangential straight lines homothetic with the internal shape of the part of the fixing devices passing through the hole.

12. Turbomachine comprising a combustion module according to claim 1.
